(19) United States
(12) Patent Application Publication
(10) Pub. No.: US 2005/0045365 A1
(43) Pub. Date: Mar. 3, 2005

(54) Cable

(76) Inventors: Jan Bladh, Alstermo (SE); Erland Erlandsson, Alghult (SE)

Correspondence Address: HARNESS, DICKEY & PIERCE, P.L.C., P.O.BOX 8910, RESTON, VA, 20195, US

(21) Appl. No.: 10/932,034

(22) Filed: Sep. 2, 2004

(30) Foreign Application Priority Data
Sep. 3, 2003 (SE) 0302350-4

(51) Int. Cl. G02B 6/44

(52) U.S. Cl. 174/108

(57) ABSTRACT

A cable (1) for carrying electricity has at least one electric conductor (8) and a sheath (2) which is made of a first material (72) and encloses said conductor (8). A wear-protecting string (6), which is made of a second material (74) having a greater hardness than the first material (72), is helically wound around the outer periphery (4) of the sheath (2). The string (6) extends into the sheath (2) and is joined thereto.

In a method of manufacturing the cable (1), the sheath (2) is formed around the conductor (8) to enclose the same. The groove (18), which extends around the sheath (2), is produced in the sheath (2). A second material (74) is applied to the groove (18) to form the string (6).

A device (30) for manufacturing the cable (1) has a groove-forming means (34) for producing the groove (18) in the sheath (2) and an application means (34) for applying the string (6).

### FIELD OF THE INVENTION

The present invention relates to a cable for carrying electricity, which cable has at least one electric conductor and a sheath which is made of a first material and encloses said conductor.

The present invention also relates to a method of manufacturing a cable for carrying electricity.

The invention further relates to a device for manufacturing a cable for carrying electricity.

### BACKGROUND ART

For carrying, for instance, electric current or data impulses, use is made of one or more conductors, for instance copper conductors, which are provided with a protective sheath to form a cable, for instance an electric cable.

In certain applications, there is a need for repeatedly moving a cable along an abrasive surface. An example of such an application involves auxiliary cables that are used to supply electric current and transmit information to an aircraft standing on a runway. When the aircraft has touched down, the auxiliary cable is dragged along the asphalt of the runway to the aircraft and is connected thereto. When the aircraft is to start, the auxiliary cable is disconnected from the aircraft and dragged along the runway away from the aircraft. Such repeated dragging of the auxiliary cable along the runway results in great wear on the sheath and makes the life of the cable short. To increase the life of the cable, sheath material has traditionally been used, that has fairly high abrasion strength without making the cable excessively rigid. This type of material with great resistance to abrasion, however, is usually very expensive and reduces the managability of the cable.

U.S. Pat. No. 6,308,741 in the name of Payne discloses a scuff cover which may be used, for example, for auxiliary cables. The scuff cover is a tube made of a mesh material and, arranged thereon, a wear strip. The tube is wrapped around a cable which is to be dragged along, and the wear strip protects the sheath of the cable during dragging along, for instance, a runway.

A drawback of the tube according to U.S. Pat. No. 6,308,741 is that it is expensive to manufacture and requires much work since it has to be wrapped around a cable.

### SUMMARY OF THE INVENTION

An object of the present invention is to reduce or eliminate the problems of prior-art technique and provide a cable that has effective protection against abrasion.

This object is achieved by a cable for carrying electricity, which cable has at least one electric conductor and a sheath which is made of a first material and encloses said conductor, said cable being characterized in that a wear-protecting string, which is made of a second material having a greater hardness than the first material, is helically wound around the outer periphery of the sheath, the string extending into the sheath and being joined thereto.

An advantage of this cable is that it will have excellent protection against abrasion for a long time since the string is joined to the sheath and thus does not risk being dislocated. The fact that the string is helically wound on the sheath has the advantage that the string protects the sheath independently of the turning position of the cable when being dragged along. A further advantage of the string being helically wound is that the abrasion strength will be much better without significantly deteriorating the bendability of the cable. It is advantageous that the string extends into the sheath on the one hand since it will be better fixed and, on the other hand, since it will provide protection against abrasion also after any projecting portions on the string have been worn down.

The wear-protecting string suitably extends into the sheath to a depth corresponding to 20-100% of the wall thickness of the sheath. The string should extend into the sheath to a depth corresponding to at least 20%, preferably at least 25% and most preferred at least 30%, of the wall thickness of the sheath to be properly fixed to the sheath and also provide protection against abrasion for a long time. In the cases when the string is combined with the sheath, it can be allowed to extend into the entire wall thickness of the sheath, i.e. to a depth corresponding to 100% of the wall thickness of the sheath. In many cases, especially when the string is not combined with the sheath, it is preferred for the string to extend into the sheath to a depth corresponding to a maximum of about 80% of the wall thickness of the sheath.

In a preferred embodiment, the string forms a helical line having a pitch of 0.5 to 4 times the outer diameter of the cable, measured on the outer periphery of the sheath, the string having a width of 0.05 to 0.3 times the pitch. For the cable to obtain good bendability, the pitch of the helical line should not be less than 0.5 times the outer diameter of the cable and, still more preferred, not less than 0.75 times the outer diameter of the cable. For the same reasons, i.e. good flexibility, the width of the string should not exceed 0.3 times the pitch. For the cable to obtain good protection against abrasion and not to be heavily worn in the portions of the cable adjoining the string, the string should not form too loose a pattern. Thus, the pitch of the helical line should not exceed 4 times the outer diameter of the cable and, still more preferred, not exceed 3 times the outer diameter of the cable. For the same reason, i.e. good protection against abrasion, the width of the string should not be less than 0.05 times the pitch.

In a preferred embodiment, the first material is a polymer material and the second material is a polymer material joinable to the first material. Polymer materials are often well suited for use as sheaths. Suitable polymer materials are thermoplastic polymers and polymers that are thermoplastic in application of the string and only after application are cured by, for instance, crosslinking. The fact that they are thermoplastic facilitates pressing of a string into the sheath. A second material which is a polymer material joinable to the first material has the advantage that the string can extend into the sheath without significantly reducing the strength of the sheath since the string will constitute an integral part of the sheath.

In another preferred embodiment, the first material is a polymer material and the second material a metal, such as stainless or galvanized steel. The fact that the material, i.e. the first material, of which the sheath is made, is a polymer material facilitates pressing of a metal string into the sheath and also allows the sheath to enclose the string and hold it. Suitable polymer materials are thermoplastic polymers, but also polymers that are thermoplastic during application of the metal string and only after application are cured by, for example, cross-linking. A metal string has the advantage that excellent protection against abrasion is provided.

Another object of the present invention is to provide a smooth method of manufacturing a cable that has effective protection against abrasion.

This object is achieved by a method of manufacturing a cable for carrying electricity, which method is characterized in that
a sheath of a first material is formed around at least one electric conductor to enclose the same,
a helical groove extending around the outer periphery of the sheath is produced in the sheath, and
a second material, which in the completed cable is harder than the first material, is applied to the groove to form a string which extends into the sheath and is joined thereto.

An advantage of this method is that cables with improved protection against abrasion can be manufactured in a continuous process and at low cost.

In a preferred method, the first material is a thermoplastic polymer, the groove being produced by the sheath being kept at a temperature exceeding the softening temperature of the first material, and by the second material being pressed into the sheath in order to produce the groove. This method has the advantage that producing of the groove and application of the string occur in one single operation. This simplifies the method and ensures that the string is safely placed in the groove due to the fact that the groove is formed by the string the moment the string is pressed into the sheath.

According to another preferred method, the first material is a polymer material, the groove in the sheath being milled. An advantage of this method is that also sheaths that are manufactured on another occasion and maybe in a different place and therefore have cooled and are not suited for a string to be pressed in, can be provided with a string. It is thus possible to buy electric cables, without wear-protecting strings, and in the sheaths of these cables mill grooves to which wear-protecting strings are then applied.

Suitably the second material is a polymer material which in its melted state is pressed into the groove and in cooling is joined to the first material. An advantage of this is that the string will be fixedly connected to the second material, which gives the sheath good abrasion strength.

A further object of the present invention is to provide a device for effective manufacture of a cable which has effective protection against abrasion.

This object is achieved by a device for manufacturing a cable for carrying electricity, which device is characterized in that it comprises an advancing means for advancing an electric conductor which is enclosed in a sheath which is made of a first material,
a groove-forming means for producing a helical groove in the sheath, said groove extending around the outer periphery of the sheath, and
an application means for applying a string, which is made of a second material, which in the completed cable is harder than the first material, to the groove in such a manner that the string extends into the sheath and is joined to the same.

This device makes it possible to manufacture cables in an effective manner and with high quality.

In a preferred embodiment of the device, the advancing means comprises a first extruder head for extruding the sheath around the conductor, the groove-forming means and the application means making up a second extruder head arranged in connection with the first extruder head, for simultaneous producing of the groove in the sheath and applying of the string to the groove by extruding the second material in its melted state. This embodiment has the advantage that extrusion of the sheath, forming of a groove in the same and applying of a string to the groove can be performed in one sequence and in a very compact device where the two extruder heads can be arranged quite close to each other or, still more preferred, be combined to one physical unit. This device requires but a small floor area and enables quick and effective manufacture of a cable with improved protection against abrasion.

In a still more preferred embodiment, the second extruder head has a string-feeding means which is arranged to rotate around the sheath to produce the helical groove and the string. The string-feeding means has the advantage that it makes it possible in an easy way to produce a helical groove around the sheath, without necessitating turning or rotation of the sheath itself. For this reason, no device for rotating of cable or conductor is required.

### BRIEF DESCRIPTION OF THE DRAWINGS

The invention will now be described in more detail with reference to the accompanying drawings.

FIG. 1 is a side view of a cable according to the invention.

FIG. 2 is a sectional view and illustrates the cable shown in FIG. 1 along section II-II.

FIG. 3 is a sectional view and shows an enlargement of the area III shown in FIG. 2.

FIG. 4 is a sectional view and illustrates the area shown in FIG. 3 after subjecting the cable to abrasion.

FIG. 5 is a sectional view and is an enlargement of a second embodiment of a cable according to the invention.

FIG. 6 is a sectional view and shows a third embodiment of a cable according to the invention.

FIG. 7 is a side view of a device for manufacturing cables according to the invention.

FIG. 8 is a sectional view of the device shown in FIG. 7.

FIG. 9 is a sectional view of the device shown in FIGS. 7 and 8 during manufacture of a cable.

FIG. 10 is a sectional view of an alternative embodiment of a device for manufacturing cables according to the invention.

FIG. 11 is a sectional view and shows a fourth embodiment of the invention in the form of a cable package.

### DESCRIPTION OF PREFERRED EMBODIMENTS

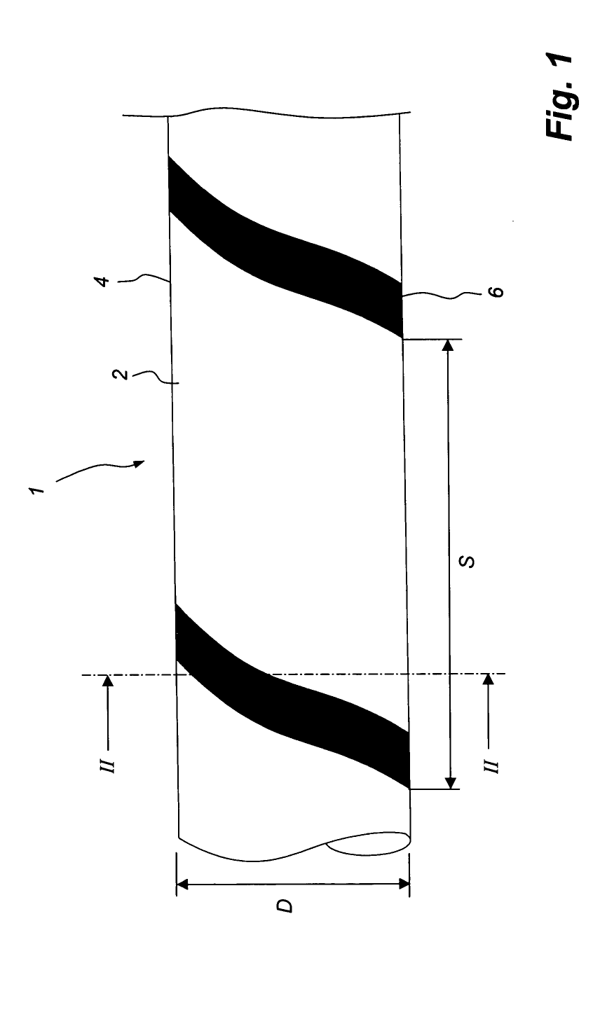

FIG. 1 shows a cable 1 in accordance with an embodiment of the invention. The cable 1 has a sheath 2 which is made of a first material that is fairly soft to allow the cable 1 to be bent. A preferred example of a material that can be used as this first material is DRYFLEX A1 600701, which is a thermoplastic elastomer of the type SEBS that is supplied by VTC Elastoteknik AB, Åmål, SE. The hardness of this material is about 70 Shore A measured according to ASTM D 2240. This hardness can be approximated with a hardness of about 17 Shore D.

On the outer periphery 4 of the sheath 2, a wear-protecting string 6 is helically wound, made of a second material having a higher hardness than the first material. A preferred example of a material that can be used as this second material is Vitamide BS10VN that is supplied by Jackdaw Polymers, Littleborough, Lancashire, GB. Vitamide BS10VN is a polyamide of medium viscosity that has a hardness of 80 Shore D according to ISO 868. Thus, the string 6 is more than twice as hard as the sheath 2, more specifically about four times as hard as the sheath 2.

The string 6 forms a helical line that has a pitch S. The pitch S is in the embodiment shown in FIG. 1 about twice the outer diameter D of the cable 1, measured on the outer periphery 4 of the sheath 2, i.e. S=2×D.

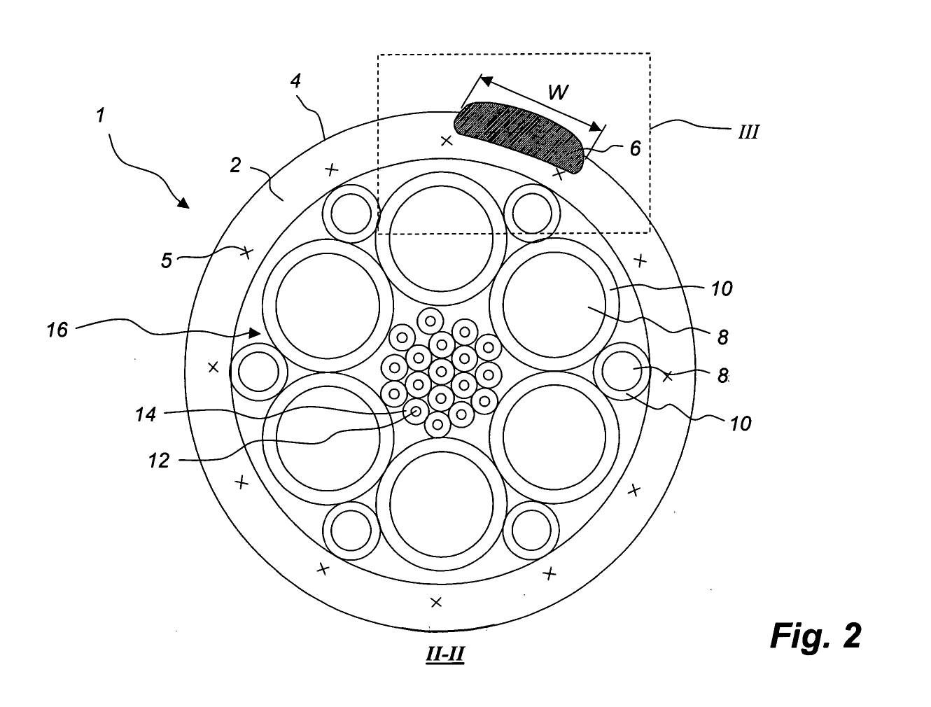

FIG. 2 illustrates the cable 1 in section II-II. A number of electric conductors 8, which are adapted to conduct electric current and, for instance, can be made of copper or some other electrically conductive material, are enclosed by an electrically insulating jacket 10 each. A number of signal conductors 12, which are made of an electrically conductive material and adapted to conduct electrical signals, are enclosed by an electrically insulating jacket 14 each. The electric conductors 8 and the signal conductors 12 are enclosed in the sheath 2 and held together by the sheath 2 as a bundle of conductors 16. The sheath 2, which can be reinforced with fibers 5, protects the bundle of conductors 16 against, for instance, sunlight, water and mechanical influence. The sheath 2 need not necessarily be electrically insulating although this is often preferred. The string 6 has a width W which is about 0.10 times the pitch S, i.e. W=0.10×S. As shown in FIG. 2, the string 6 extends into the sheath 2.

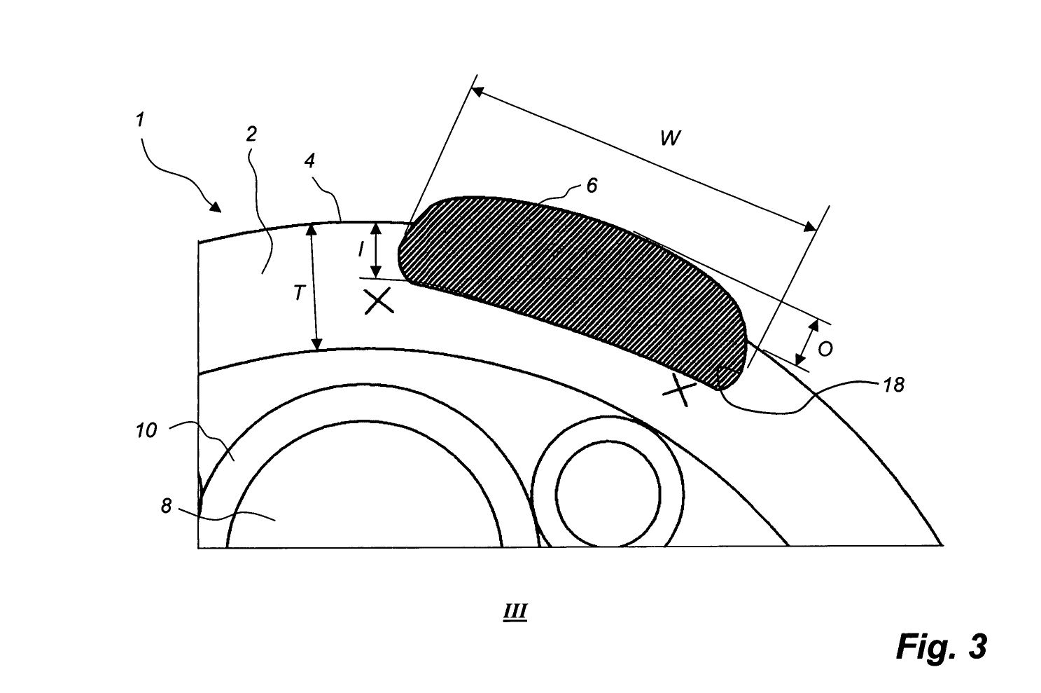

FIG. 3 shows the string 6 on a larger scale. As is evident, the sheath 2 has a wall thickness T. The wall thickness T is adjusted to, among other things, the size of the bundle of conductors 16 and the field of application of the cable 1. A cable 1 that is used as an auxiliary cable at an airport can typically have a sheath 2 with a wall thickness T of about 2-5 mm. The string 6 extends down into the sheath 2 from the outer periphery 4 thereof a distance I that corresponds to about 50% of the wall thickness T of the sheath 2. This means that the string 6 is attached to a groove 18 in the sheath 2. The first material, of which the sheath 2 is made, and the second material, of which the string 6 is made, have been chosen in such a manner that the string 6, during the manufacturing process that will be described in more detail below, has been combined with the sheath 2 and thus will add to the strength of the sheath 2.

The string 6 projects beyond the outer periphery 4 of the sheath a distance O. The distance O is typically about 1-3 mm.

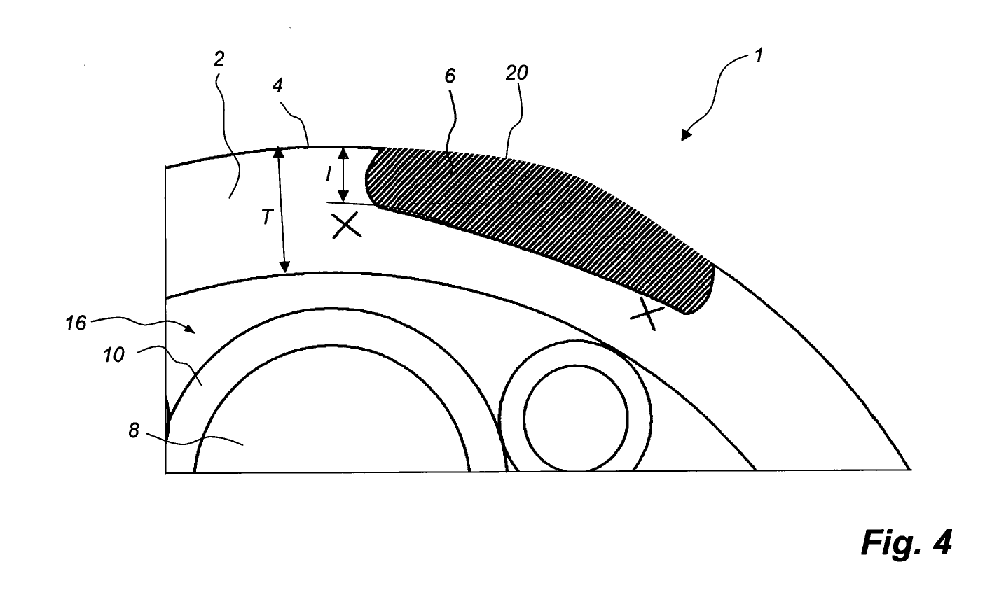

FIG. 4 illustrates the cable 1 shown in FIG. 3 after being exposed to wear by being dragged over asphalt during a first period of time. As will be seen, the string 6 has been worn down so that the outer boundary surface 20 of the string 6 is essentially aligned with the outer periphery 4 of the sheath 2. During said first period of time, the string 6 has thus protected the sheath 2 against abrasion by the cable 1 sliding on the string 6 over the asphalt. The projecting part of the string 6, i.e. the distance O shown in FIG. 3, has thus been worn off. However, it has been found that the string 6 also in the state shown in FIG. 4 protects the sheath 2 against abrasion. The cable 1 can thus also be used during a second period of time which may be considered to begin when the string 6 has been worn down to be aligned with the outer periphery 4 of the sheath 2 and end when the sheath 2 at some point does no longer enclose the bundle of conductors 16, i.e. when the sheath 2 is to be considered worn out. During this second period of time, the cable 1 will slide on both the string 6 and the sheath 2. It has been found that the string 6 during this second period of time makes the sheath 2 last for a considerably longer period than would have been the case if the string 6 had not existed. It has also been found that the second period of time usually is considerably longer than the first period of time. It is thus most important for the string 6 to extend into the sheath 2 to provide good wear properties. It is desirable, but not crucial, that the string 6 also projects out of the periphery 4 of the sheath 2. Since the string 6 is combined with the sheath 2, the strength of the sheath 2 will not be deteriorated even if the string extends through the entire wall thickness of the sheath 2, i.e. a distance I that corresponds to 100% of the wall thickness T of the sheath 2.

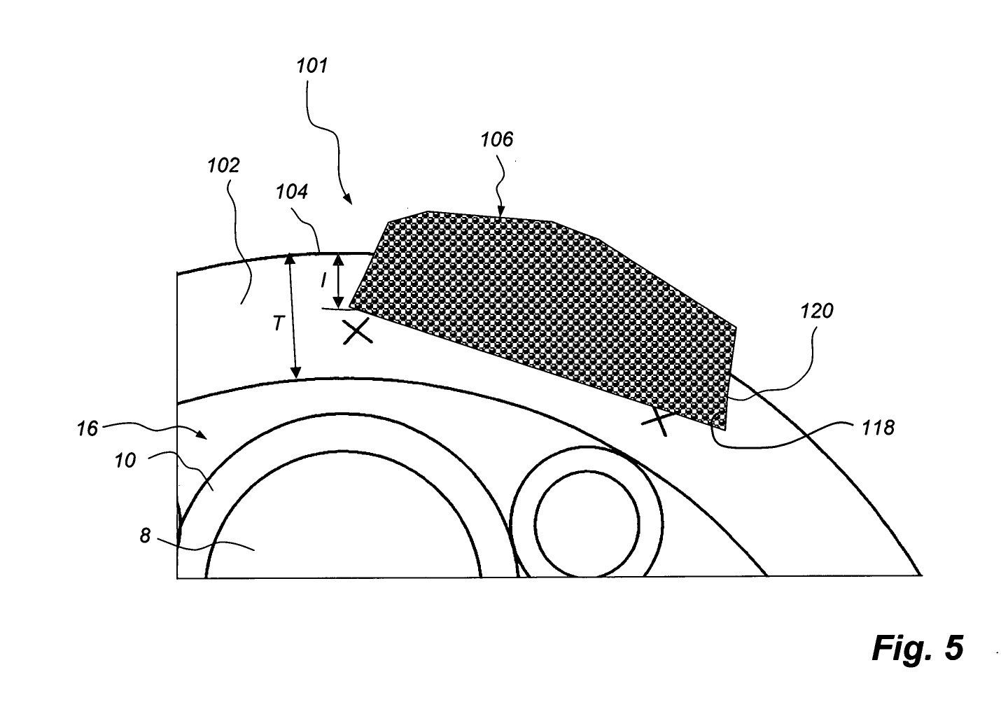

FIG. 5 illustrates an alternative embodiment of the invention in the form of a cable 101. The cable 101 differs from the cable 1 shown in FIGS. 1-4 as regards the design of the string. The cable 101 thus has a sheath 102 which is made of a first material that is fairly soft to allow the cable 101 to be bent. This first material is suitably a polymer plastic material, for instance the above-mentioned thermoplastic elastomer DRYFLEX A1 600701. A wear-protecting string in the form of a braid 106 is helically wound on the outer periphery 104 of the sheath 102. The braid 106 is made of a second material that has a higher hardness than the first material. Suitable second materials for manufacturing the braid are stainless steels, but also some hard polymer materials that can be braided, may be used. The braid 106 extends into the sheath 102 from the outer periphery 104 thereof a distance I corresponding to about 50% of the wall thickness T of the sheath 102. The braid 106 is thus attached to a groove 118 in the sheath 102.

When applying the braid 106, the sheath 102 is heated to a temperature that allows it to soften. The braid 106 is then pressed into the soft sheath 102. The groove 118 can either be made in advance, in which case the braid 106 is pressed into the groove 118 made in advance, or be made by the braid 106 being pressed into the soft sheath 102 at the periphery 104 thereof and thus form the groove 118 while at the same time being pressed into the sheath 102. Since the sheath 102 is soft, the polymer material thereof will partly penetrate between the fibers 120 of the braid 106. When the sheath 102 is cooled to room temperature, it will thus be combined with the braid 106 even if this has fibers 120 of stainless steel, and will thus in a reliable manner hold the braid 106 in use of the cable 101.

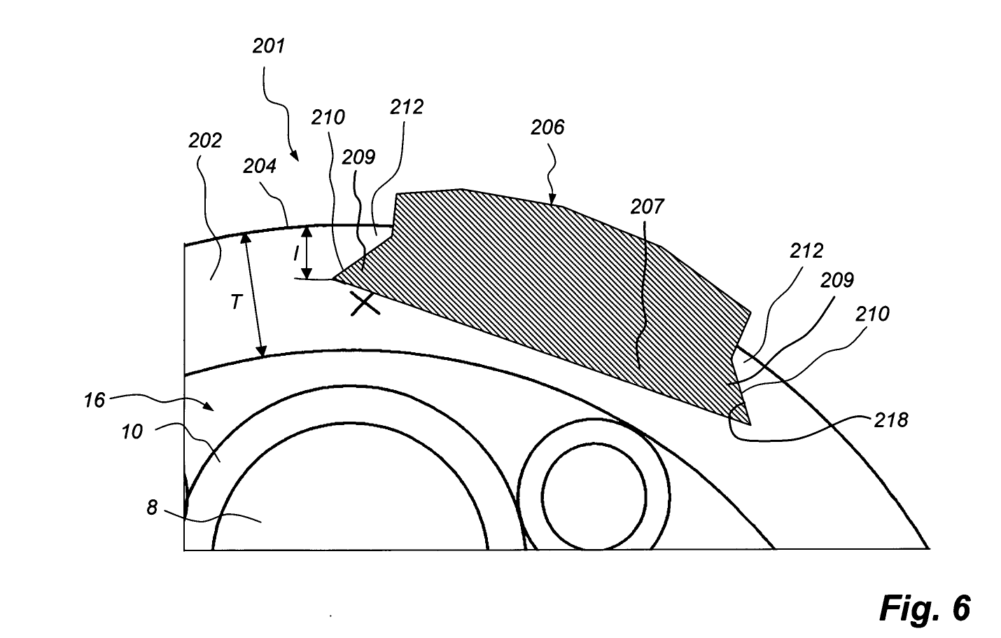

FIG. 6 illustrates a further alternative embodiment of the cable 1 shown in FIGS. 1-4. The cable 201 differs from the cable 1 shown in FIGS. 1-4 as regards the design of the string. The cable 201 thus has a sheath 202 which is made of a first material that is fairly soft to allow the cable 201 to be bent. This first material is suitably a polymer plastic material, for instance the above-mentioned thermoplastic elastomer DRYFLEX A1 600701. A wear-protecting string in the form of a sectional element 206 is helically wound on the outer periphery 204 of the sheath 202. The sectional element 206 is made of a second material that has a higher hardness than the first material. Suitable second materials for making the sectional element are metal materials, such as stainless steels and aluminum, hard polymer materials, such as polyamide etc. The sectional element 206 extends into the sheath 202 from the outer periphery thereof 204 a distance I corresponding to about 50% of the wall thickness T of the sheath 202. The sectional element 206 has in the portion 207 that is adapted to extend into the sheath 202 projections 209 which extend in the circumferential direction of the sheath 202. Thus the portion 207 is at its widest furthest down in the sheath 202 and tapers towards the periphery 204 of the sheath 202. The projections 209 will thus form lugs 210 that hold the sectional element 206 in the sheath 202.

When applying the sectional element 206, the sheath 202 is heated to a temperature that allows it to soften. The sectional element 206 is then pressed into the soft sheath 202. A groove 218 can either be made in advance, in which case the sectional element 206 is pressed into the groove 218, or be made by the sectional element 206 being pressed into the sheath 202 at the periphery 204 thereof and thus forming the groove 218 while being pressed into the soft sheath 202. Since the sheath 202 is soft, the polymer material thereof will fit tightly against the lugs 210. When the sheath 202 is cooled to room temperature, it will thus form holding fastening portions 212 which extend over the lugs 210 on both sides of the sectional element 206 and thus hold the sectional element 206.

In the cases where the sectional element 206 is made of a material, for instance stainless steel, that is not combined with the sheath 202, it is convenient for the sectional element 206 not to extend particularly far into the wall thickness T of the sheath 202. Thus, a sectional element 206 of metal should extend into the sheath 202 a distance I corresponding to a maximum of about 80% of the wall thickness T of the sheath so as not to significantly reduce the strength of the sheath 202.

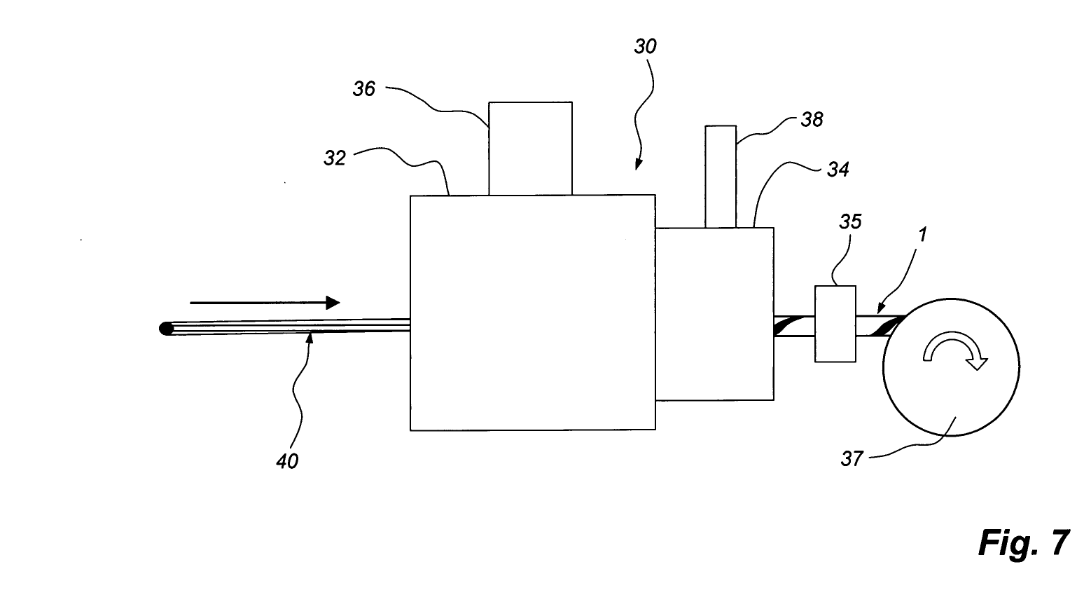

FIG. 7 illustrates a device 30 for manufacturing the cable 1 shown in FIGS. 1-4. The device 30 has a first part in the form of a first extruder head 32 and a second part in the form of a second extruder head 34 arranged beside the first extruder head 32. The first material, for instance thermoplastic elastomer, is fed in its melted state to the first extruder head 32 through an inlet 36. The second material, for instance polyamide, is fed in its melted state to the second extruder head 34 through an inlet 38. A conductor package 40, which comprises one or more conductors, for instance the above-described bundle of conductors 16 with electric conductors 8 and signal conductors 12, is fed to the first extruder head 32 and, in the same, provided with a sheath 2, as will be described in more detail below. The conductor package 40 provided with a sheath 2 is then fed directly to the second extruder head 34 where a string 6 is pressed into the sheath 2. The completed cable 1 leaves the second extruder head 34 and is, after cooling, ready for use. An advancing device 35 is arranged after the second extruder head 34. The advancing device 35, which is driven by a motor (not shown), exerts a tractive force on the cable 1 and thus helps to feed the conductor package 40 into the device 30. The advancing device 35 will therefore, together with the first extruder head 32, form an advancing means that advances the conductor package 40 provided with the sheath 2 to the second extruder head 34. As a rule, the completed cable 1 is wound onto a cable drum 37.

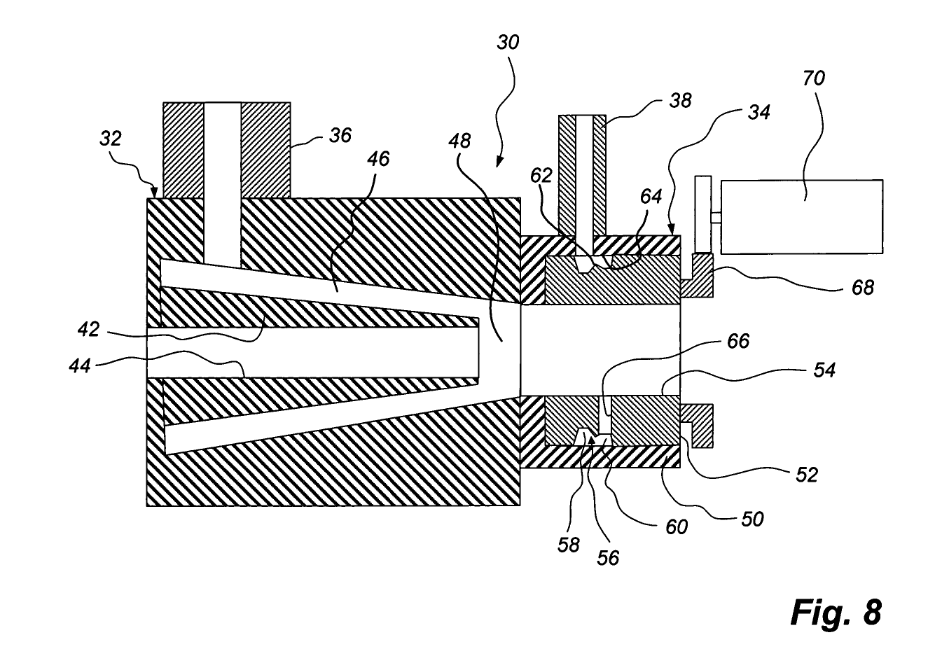

FIG. 8 is a cross-sectional view of the device 30 shown in FIG. 7. The first extruder head 32 has a nipple 42 which is adapted to center to conductor package 40 and prevent melted polymer from leaking out from the extruder head 32 the back way. The nipple 42 thus forms a feed pipe 44 through which the conductor package 40 is suplied to the extruder head 32. The first extruder head 32 has a pressure distributor 46 which communicates with the inlet 36 and is arranged to receive the first material in its melted state. The pressure distributor 46 serves to distribute the first material around the conductor package 40 and, at an even pressure along the periphery of the conductor package 40, apply the first material around the conductor package 40 to form the sheath 2 around the same. In the position where the feed pipe 44 of the nipple 42 and the pressure distributor 46 meet, there forms a nozzle 48 where the sheath 2 is formed around the conductor package 40.

The second extruder head 34 follows immediately after the nozzle 48. The second extruder head 34 has a housing 50 and a cylindrical sleeve 52 which is arranged in the housing 50 and can rotate in the same. The sleeve 52 has a discharge pipe 54 through which the conductor package 40 provided with a sheath 2 can be discharged from the device 30. The sleeve 52 has a recess 56 around its outer periphery. The recess 56 has a first chamber 58 and a second chamber 60, which is smaller than the first chamber 58. The chambers 58, 60, which are defined radially outwards by the inside 64 of the housing 50, communicate with each other but are partially separated by a ridge 62. The inlet 38 for the second material opens into the first chamber 58. The melted second material will thus be supplied to the first chamber 58. Due to the ridge 62, the chamber 58 will have a pressure-distributing effect and thus provide the second chamber 60 with melted material at an essentially constant pressure. The second chamber 60 opens into a string-feeding means in the form of a string-feeding hole 66 which extends radially towards the center of the sleeve 52. The string-feeding hole 66 feeds, at a point rotating around the periphery 4 of the sheath 2, the melted second material down to and into the still soft sheath 2 to form the string 6. Thus the chambers 58, 60 will have a pressure-distributing effect, which results in the melted second material being pressed into the sheath 2 with the same force, independently of the rotary position of the sleeve 52 relative to the inlet 38 for the melted second material. The sleeve 52 is provided with a gear rim 68. The gear rim 68 is driven by a motor 70 in such a manner that the sleeve 52 rotates around the conductor package 40 at a desired speed. This speed is coordinated with the feeding speed of the conductor package 40 in such a manner that the string 6 will form a helical line with a desired pitch around the periphery of the sheath 2.

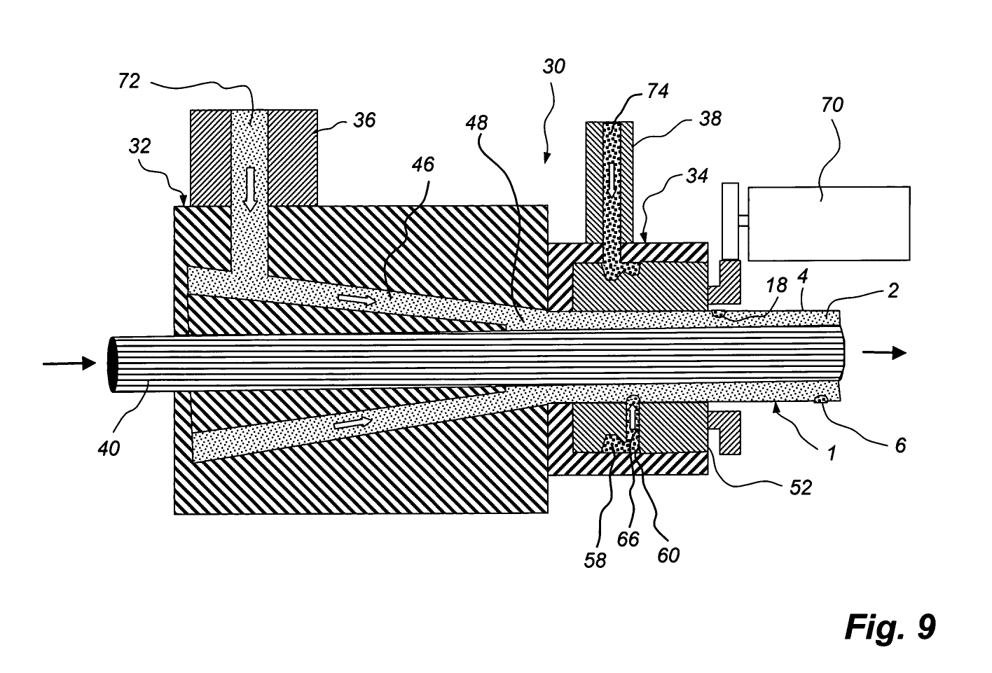

FIG. 9 shows the device 30 in the same section as in FIG. 8, but showing the first and second materials as well as the conductor package 40 and the cable 1. As is evident from FIG. 9, the first material 72 is supplied from a first extruder (not shown), which stores melted material, into the inlet 36, on to the pressure distributor 46, as is indicated by arrows in FIG. 9, and distributed around the conductor package 40. If the first material 72 is the above-mentioned thermoplastic elastomer, the melted material has a temperature of about 200° C. In the nozzle 48, the sheath 2 is then formed around the conductor package 40.

The second material 74 is supplied from a second extruder (not shown), which stores melted material, through the inlet 38 to the first chamber 58, as indicated by an arrow in FIG. 9, and on to the second chamber 60. The second material 74 is then passed through the string-feeding hole 66 towards the sheath 2. If the second material 74 is the above-mentioned polyamide, the melted second material 74 has a temperature of about 250° C. The melted second material 74 is pressurized. This, along with the fact that the sheath 2 is still soft, results in the second material 74 being pressed into the sheath 2. The second extruder head 34 thus serves as a groove-forming means since the pressurized second material 74 is pressed into the soft sheath 2 and, thus, forms a groove 18 in the periphery 4 of the sheath 2. During forming of the groove 18, the second material 74 is applied to the groove 18 by the extruder head 34 and fills the groove. Thus, the second extruder head 34 also serves as an application means by the second extruder head 34, at the moment of producing the groove 18, also applying the string 6 to this groove 18. The fact that the second material 74 is applied under pressure often results in the string 6, after the cable 1 has left the sleeve 52, bulging somewhat from the periphery 4 of the sheath 2. This is, however, as mentioned above, not a drawback. Since the sleeve 52 is rotated around the conductor package 40 and, thus, around the sheath 2, the string-feeding hole 66 will be rotated around the sheath 2 and form the helical string 6. After cooling of the sheath 2 and the string 6, they will fuse in such a manner that a cable 1 with high abrasion resistance is obtained.

As the method of manufacture has been described with reference to FIGS. 7-9, the conductor package 40 is advanced without being rotated, the sleeve 52 and, thus, the string-feeding hole 66 being rotated around the conductor package 40 to form the helical string 6 around the periphery 4 of the sheath 2. Of course, it is also possible to rotate the conductor package 40 instead, for instance by the cable drum, from which the conductor package 40 is unwound, being rotated on a rotary axis which is perpendicular to the longitudinal axis of the cable drum, and hold a string-feeding hole fixed and yet provide the helical string. For practical reasons, it is however frequently easier to rotate the sleeve 52 and not the conductor package 40.

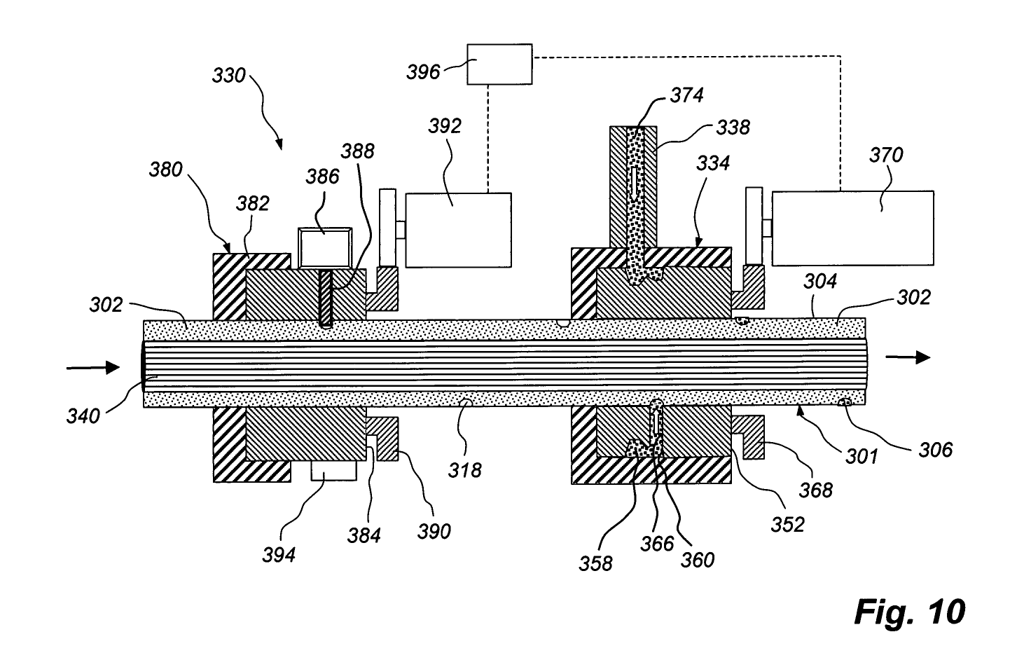

FIG. 10 illustrates an alternative embodiment of a method of manufacturing a cable according to the invention. In the method shown in FIG. 10, use is made of a device 330 for manufacturing a cable 301 from a conductor package 340 which has been provided in advance with a sheath 302 of a first material, for instance a thermoplastic elastomer. The device 330 has a groove-forming means 380 and an extruder head 334. The conductor package 340 with the completed sheath 302 is first supplied to the groove-forming means 380, as indicated by an arrow in FIG. 10. The groove-forming means 380 has a bearing housing 382 and a rotor 384 mounted in the bearing housing 382. On the rotor there is a milling cutter 386 which by means of a milling tool 388 can mill a groove 318 in the sheath 302. The rotor 384 is provided with a gear rim 390. A motor 392 drives the gear rim 390 and thus rotates the rotor 384 around the sheath 302. A counterweight 394 on the rotor 384 balances the milling cutter 386. By the conductor package 340 with the sheath 302 being fed through the rotor 384 while this is being rotated by the motor 392, the milling tool 388 will form the desired helical groove 318 around the periphery 304 of the sheath 302. The conductor package 340, which is thus provided with a helical groove 318 in its sheath 302, is then fed to the extruder head 334. The extruder head 334 is essentially identical to the second extruder head 34 as described above with reference to FIGS. 7-9. Thus the extruder head 334 has an inlet 338 for a second material 374 in its melted state, for instance a polyamide at a temperature of 250° C. The second material 374 is fed to a first chamber 358 in a rotatable sleeve 352 which is of essentially the same type as the sleeve 52 that has been described above. The sleeve 352 is rotated by a motor 370 which drives a gear rim 368. A string-feeding hole 366 extends from a second chamber 360 communicating with the first chamber 358 and towards the center of the sleeve 352. The string-feeding hole 366 applies the melted second material 374 to the groove 318 to form a string 306. The string 306 and the sheath 302 are then cooled, and the thus manufactured cable 301 can be wound onto a cable drum (not shown) and is ready for use. Since the second material 374 has a high temperature, it will heat the edges of the groove 318 and thus the string 306 is combined with the sheath 302 in the groove 318 as the string 306 cools off. It will be appreciated that the groove-forming means 380 and the extruder head 334 must be coordinated with one another. A control device 396 controls the motors 392, 370 in such a manner that the milling tool 388 mills a helical groove 318 with a desired pitch and the extruder head 334 applies the string 306 to the groove 318.

The device 330 shown in FIG. 10 can be modified so that the cable package 340 is rotated and instead the milling tool 388 and the string-feeding hole 366 are kept fixed. Although it is frequently preferred for the sheath 302 to be made of a thermoplastic polymer, it is of course also possible to mill grooves in sheaths that are not made of thermoplastic polymer materials.

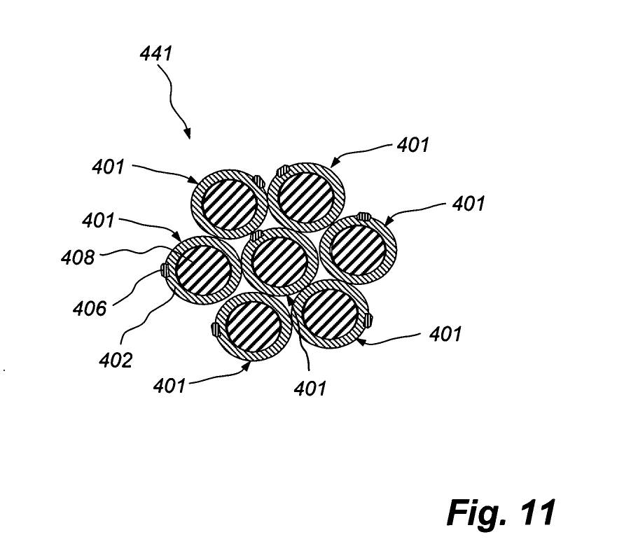

FIG. 11 illustrates a fourth embodiment of the present invention in the form of a cable package 441. The cable package consists of seven cables 401, which each have a single conductor 408 enclosed by a sheath 402. Each sheath 402 is provided with a string 406. The string 406 has been applied to the sheath 402 for instance in the manner described above with reference to FIGS. 7-9. Thus, in a first step a number of cables 401 have been manufactured separately, which each have a sheath 402 and an associated, helically wound string 406 which extends into the sheath 402 in the manner described in connection with FIG. 3. The seven cables 401 have then, in a second step, been wound around each other by means of twisting so as to produce a cable package 441. Twisting results in the cables 401 not tending to unwind from each other, and the cable package 441 will have a permanent rope-like structure. Since each cable 401 is provided with a helically wound wear-protecting string 406, the cable package 441 will obtain good protection against abrasion. Of course, it is also possible to let each cable 401 comprise a plurality of separate conductors, instead of a single conductor 408.

It will be appreciated that many modifications of the above-described embodiments are feasible within the scope of the invention.

Consequently many different materials can be selected as the first material and the second material, which is harder than the first material. It is particularly preferred to choose the first and second materials in such a manner that the first and second materials are combined with each other when applying the string. An example of such a combination is the above-mentioned thermoplastic polymer, which is a polymer of the type SEBS (styrene ethylene/butylene styrene), in combination with the above-mentioned polyamide. A further example is to use as a first material, i.e. for the sheath, a soft polyurethane and as a second material, i.e. for the string, a hard polyurethane which is easily combined with the soft polyurethane of the sheath.

Further materials that may be convenient as a first material are, among other things, what is referred to as polyofins and vulcanizable rubber, which are materials that can be made to cure after application of the string. An example of a curing polymer composition is Catapyrric SX538H:CM540U supplied by AEI Compounds Limited, Gravesend, Kent, GB. Catapyrric SX538H:CM540U can be extruded to form a sheath around a cable and has during extrusion thermoplastic properties. After extrusion and application of a string, Catapyrric SX538H:CM540U is cured by being immersed in a hot water bath or by being subjected to vapor of at most 65° C. In curing, crosslinking of molecule chains occurs and the thermoplastic properties will be lost. Catapyrric SX538H:CM540U can be used as a first material, i.e. for the sheath, for cables that are subjected to wear and also have to resist high temperatures. Since Catapyrric SX538H:CM540U has thermoplastic properties before curing, it can be applied by means of the device 30 shown in FIGS. 7-9 and is not cured until after a string 6 has been applied to a groove 18. Curing polymer compositions, such as Catapyrric SX538H:CM540U, can of course also be used in the device shown in FIG. 10 either before or after curing.

The hardness of the first material, i.e. the material used for the sheath, is suitably about 50-100 Shore A according to ASTM D 2240. The hardness is selected, for instance, with regard to the diameter of the cable and the environment in which it is to be used. The second material, of which the string is made, suitably has a hardness which is at least about 50% higher than the hardness of the first material. It is still more preferred for the hardness of the second material to be at least about 75% higher than the hardness of the first material.

As discussed above, a string is applied around the periphery of a sheath. It is also possible to apply 2, 3, 4 or even more helical strings around a sheath. These strings are suitably applied uniformly distributed around the diameter of the sheath and with such distribution that the desired protection against abrasion is achieved without the cable being excessively rigid. The device 30 shown in FIGS. 7-9 can, for example, easily be modified by a plurality of string-feeding holes, uniformly distributed around the diameter of the sheath, being formed in the sleeve 52 for simultaneous application of a plurality of strings.

1. A cable for carrying electricity, comprising:
at least one electric conductor;
a sheath, made of a first material and enclosing said at least one conductor; and
a wear-protecting string, made of a second material having a greater hardness than the first material, helically wound around an outer periphery of the sheath, the string extending into and being joined to the sheath.

2. A cable as claimed in claim 1, wherein the wear-protecting string extends into the sheath to a depth corresponding to 20-100% of a wall thickness of the sheath.

3. A cable as claimed in claim 1, wherein the string forms a helical line having a pitch of 0.5 to 4 times the outer diameter of the cable, measured on the outer periphery of the sheath, the string having a width of 0.05 to 0.3 times the pitch.

4. A cable as claimed in claim 1, wherein the first material is a polymer material and the second material is a polymer material joinable to the first material.

5. A cable as claimed in claim 1, wherein the first material is a polymer material and the second material is a metal.

6. A method of manufacturing a cable for carrying electricity, comprising:
forming a sheath, of a first material, around at least one electric conductor to enclose the at least one conductor;
producing a helical groove extending around an outer periphery of the sheath; and
applying a second material, which in the completed cable is harder than the first material, to the groove to form a string which extends into and is joined to the sheath.

7. A method as claimed in claim 6, wherein the first material is a thermoplastic polymer, and wherein the groove produced by the sheath is kept at a temperature exceeding the softening temperature of the first material, and wherein the second material is pressed into the sheath in order to produce the groove.

8. A method as claimed in claim 6, wherein the first material is a polymer material, and wherein the groove in the sheath is milled.

9. A method as claimed in claim 7, wherein the second material is a polymer material which in its melted state is pressed into the groove and in cooling is joined to the first material.

10. A device for manufacturing a cable for carrying electricity, comprising:
advancing means for advancing an electric conductor, the electric conductor being enclosed in a sheath made of a first material;
groove-forming means for producing a helical groove in the sheath, said groove extending around an outer periphery of the sheath; and
application means for applying a string, made of a second material which, in the completed cable, is harder than the first material, to the groove in such a manner that the string extends into and is joined to the sheath.

11. A device as claimed in claim 10, wherein the advancing means comprises a first extruder head for extruding the sheath around the conductor, the groove-forming means and the application means making up a second extruder head arranged in connection with the first extruder head, for simultaneous
producing of the groove in the sheath and applying of the string to the groove by extruding the second material in its melted state.

12. A device as claimed in claim 11, wherein the second extruder head includes a string-feeding means for rotating around the sheath to produce the helical groove and the string.

13. A cable as claimed in claim 2, wherein the string forms a helical line having a pitch of 0.5 to 4 times the outer diameter of the cable, measured on the outer periphery of the sheath, the string having a width of 0.05 to 0.3 times the pitch.

14. A cable as claimed in claim 5, wherein the metal is at least one of stainless and galvanized steel.

15. A method as claimed in claim 8, wherein the second material is a polymer material which in its melted state is pressed into the groove and in cooling is joined to the first material.
